(19) United States
(12) Patent Application Publication
(10) Pub. No.: US 2024/0305348 A1
(43) Pub. Date: Sep. 12, 2024

(54) METHOD FOR DETERMINING A TRANSMISSION SIGNAL IN A PLURALITY OF RECEIVED SIGNALS

(71) Applicant: MEYSENS GMBH, Munich (DE)

(72) Inventors: Alexander RUDOY, Munich (DE); Michele CORONA, Munich (DE); Christian WELK, Munich (DE)

(21) Appl. No.: 18/572,442

(22) PCT Filed: Jun. 29, 2022
(86) PCT No.: PCT/EP2022/067945

§ 371 Date: Dec. 20, 2023

(30) Foreign Application Priority Data
Jun. 29, 2021 (LU) LU500347

(51) Int. Cl. H04B 7/06; H04L 5/00

(52) U.S. Cl. CPC H04B 7/068; H04B 7/0684; H04L 5/0048

(57) ABSTRACT

The invention relates to a method for determining a transmission signal in multiple received signals (6, 8, 11), wherein the method has the following steps:
sending a transmission signal (3)
receiving a first signal (6), which contains the transmission signal via a first receiver (5) and
receiving a second signal (8), which contains the transmission signal via a second receiver (7), characterized in that
to determine the transmission signal in the received signals (6, 8), the received signals (6, 8) are compared with one another, wherein the comparison comprises a determination of a time difference and/or phase difference between the first signal (6) and the second signal (8), wherein a transmission signal time period (25), in which the transmission signal is contained in the first signal (6) and the second signal (8), depends on the determined time difference and/or phase angle difference.

The invention relates to a method for determining a transmission signal in multiple received signals, wherein the method comprises sending a transmission signal, receiving a first signal which contains at least part of the transmission signal via a first receiver and receiving a second signal which contains at least part of the transmission signal via a second receiver. In addition, the invention relates to the use of such a method in three-dimensional position determination and a device with at least one transmitter, a first receiver and a second receiver.

Sensors are known from the prior art which have a transmitter that actively emits an ultrasonic wave and detects reflections from various objects that are in the field of view of the sensor by means of at least one receiver. In addition to reflecting the actively generated sound wave, the sensor also picks up ambient noise and other types of noise.

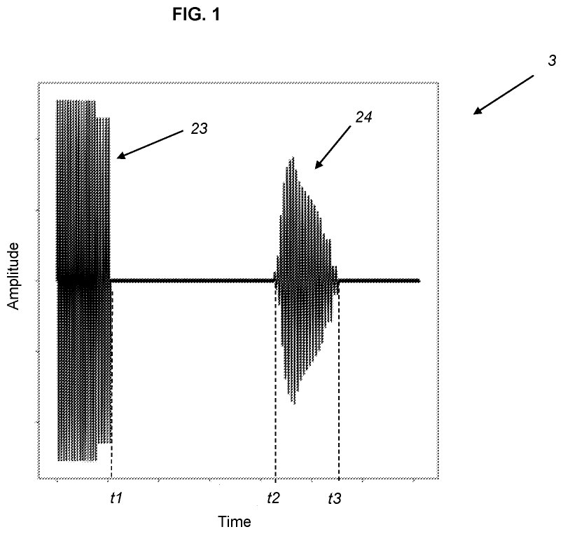

FIG. 1 shows a section of a signal 3 received by a receiver. In particular, FIG. 1 shows the amplitude curve of the received signal 3 over time, wherein the vertical axis represents the amplitude and the horizontal axis represents the time. A first signal region 23 up to the first time t1 represents the emitted sound wave, which is recorded directly between the transmitter and receiver. A second signal region 24 recorded between a second time t2 and a third time t3 represents an interesting section of the received signal 3. The remaining portions of the received signal can be considered noise. The interesting section could be the reflection of the actively emitted sound wave or some other loud noise. It is therefore necessary to determine whether this section is a reflected transmission signal or interference noise.

In known methods it is assumed that the actively emitted sound wave corresponds to the section of the received signal whose amplitude is greater than a predetermined threshold value. However, such a method has the disadvantage that it is inaccurate, in particular as loud ambient noises, i.e., noises with high amplitude, are incorrectly recorded as a reflected transmission signal.

The object of the invention is therefore to provide a method by means of which the transmitted signal can be precisely determined in the received signal.

The object is achieved by a method for determining a transmission signal in multiple received signals, wherein the method has the following steps:
sending a transmission signal,
receiving a first signal containing at least part of the transmission signal via a first receiver and
receiving a second signal, which contains at least part of the transmission signal via a second receiver, characterized in that
to determine the transmission signal in the received signals, the received signals are compared with one another, wherein the comparison comprises a determination of a time difference and/or phase difference between the first signal and the second signal, wherein a time period, in which the transmission signal is contained in the first signal and the second signal, depends on the determined time difference and/or phase difference.

A further object of the invention is to provide a device by means of which the transmitted signal can be determined in the received signal.

The object is achieved by a device with at least one transmitter for sending a transmission signal, a first receiver for receiving a first signal which contains at least part of the transmission signal, a second receiver for receiving a second signal which contains at least part of the transmission signal, characterized in that the device has an evaluation device which compares the received signals with one another to determine the transmission signal in the received signals, wherein the comparison comprises a determination of a time difference and/or phase angle difference between the first signal and the second signal, wherein a transmission signal time period, in which the transmission signal is contained in the first signal and the second signal, depends on the determined time difference.

According to the invention, it was recognized that by comparing the first and second signals, the transmission signal time period in which the first signal and the second signal contain the transmission signal can be determined in a simple manner. This is possible because in the transmission signal time period the first signal and the second signal have an essentially identical course. In particular, it was recognized that by relying on the time difference between the first signal and the second signal, a transmission signal time period of the first received signal and the second received signal that contains the transmission signal can be determined particularly easily. The received signals can be time-delayed from one another. Since the distance between the receivers is at most, in particular less than, half a wavelength of the received signal and/or the highest frequency of the transmitted signal or the received signal, this ensures that the received signals overlap. This is the case if the receivers receive the signals at different times due to their arrangement relative to one another. It is irrelevant to the method whether the first and/or second receiver receives the transmission signal directly, i.e., a non-reflected transmission signal, or a reflected transmission signal.

The transmission signal can be a wave, in particular an electromagnetic wave, or a pressure wave, in particular a sound wave. The received signal can be a wave, in particular an electromagnetic wave, or a pressure wave, in particular a sound wave. The evaluation device can be a processor or have at least one processor.

The transmitter can emit the transmission signal in all spatial directions or at least in a half-space. In particular, the transmitter can be a sound transmitter. In addition, the transmitter can have at least one piezo component by means of which the transmission signal can be generated. The receiver is designed to receive the transmission signals emitted by the transmitter, in particular the transmission signals that are at least partially reflected by the object.

In a particular embodiment, the transmitter can be controlled to generate the transmission signal using a predetermined number of control signals. Alternatively or additionally, the transmission signal can be output for a predetermined time period. The transmission signal is therefore not received continuously via the receiver or receivers, in particular not during the entire receiving process. The predetermined time period during which the transmission signal is output is less than the time period during which the receivers receive signals. The transmitter can be controlled in such a way that the transmitted signal output has a sinusoidal curve. The control signal can have a rectangular shape.

The control signal can be a modulated signal. This is possible because only the received signals are compared with one another and the process therefore works. With a modulated signal, the transmission time can also be determined with a continuous signal, even if it is generated by another transmitter.

The transmission signal can be at least partially reflected by an object. The receivers can receive the at least partially reflected transmission signal. In addition, the transmission signal can be transmitted directly to at least one receiver. In addition, the transmission signal can be received via at least one receiver without reflection, i.e., without the transmission signal being reflected by an object. The evaluation device therefore knows the time at which the transmission signal is sent. The transmission of the transmission signal directly to the at least one receiver can take place each time the transmission signal is output by the transmitter. Alternatively, the transmission signal can be transmitted to the receiver at specific times. However, the time at which the transmission signal is sent is irrelevant for determining the transmission signal in the received signals. The time difference and/or phase angle difference can be determined independently of the transmission time. The method also works with more than two receivers and/or with more than two received signals.

A method in which the transmission signal is a non-modulated transmission signal, in particular is not modulated by the control signal, is particularly advantageous. Likewise, the received signal cannot be modulated. In particular, there is no frequency and/or amplitude modulation of the transmitted signal and/or the received signal. This avoids time-consuming calculations in the evaluation device. The use of non-modulatable transmitters is also possible.

The device can have a housing, wherein the evaluation device can be arranged in an interior of the housing. The at least one receiver, in particular at least two receivers, and the transmitter can be mechanically connected to the housing. The evaluation device can carry out the necessary method steps when determining the transmission signal.

A signal section of the first received signal and another signal section of the second received signal that are compared with one another may have the same phase angle range. If a third signal is received via a third receiver, another signal section of the third signal, which is compared with the signal section of the first signal and/or the further signal section of the second signal, can have the same phase angle range as the signal section of the first signal and the further signal section of the second signal. The phase angle refers to the respective signal and not to an absolute phase angle. This occurs because the receivers do not receive the signals at the same time, but with a time delay. As a result, identical signal sections of the received signals should be compared with one another.

In a particular embodiment, the received first signal can be divided into several signal sections. The signal sections of the first signal can have the same phase angle range. The phase angle range can be 90°, 180° or 360°. However, other phase angle ranges are also possible. The individual signal sections are arranged offset from one another, particularly in terms of time.

The evaluation device can determine a curve function of the signal section. In particular, the evaluation device can determine the course of each signal section. The course of the signal section can be determined by at least one algorithm. The determination can also have fitting. As already described above, the transmission signal can have a sinusoidal curve. This makes it particularly easy to determine the course of the signal section.

The evaluation device can determine one or more signal points in the signal section. In particular, the evaluation device can determine one or more signal points in each signal section. The signal points can be determined in a simple manner if, as described above, the curve function of the signal section is determined.

In addition, the evaluation device can determine a time and/or phase angle assigned to the signal point. When determining several signal points, the evaluation device can determine the time and/or phase angle assigned to the signal point for each signal point. This makes it easy to know at what time the respective signal point is present.

The signal points of the first signal can be arranged offset from one another, in particular by a predetermined phase angle. Alternatively or additionally, the at least two signal points can each be arranged offset from a reference point by a predetermined phase angle. In addition, the signal points are arranged offset from one another in terms of time.

The signal point can be a point that characterizes the course of the signal section. The signal point can be a maximum, a minimum, a zero crossing or a turning point of the signal section. Alternatively or additionally, a signal point can be any point of the signal section with a predetermined phase angle or a predetermined phase angle difference to another signal point or a reference point.

In a particular embodiment, the received second signal can be divided into several further signal sections. The further signal sections of the second signal can have the same phase angle range. The phase angle range can be 90°, 180° or 360°. However, other phase angle ranges are also possible. The individual further signal sections are arranged offset from one another, in particular in terms of time.

The evaluation device can determine a curve function of the further signal section, in particular of each further signal section. In particular, the evaluation device can determine the course of each additional signal section. The course of the further signal section can be determined by at least one algorithm. As already described above, the transmission signal can have a sinusoidal curve. This makes it particularly easy to determine the course of the further signal section.

The evaluation device can determine one or more further signal points in the further signal section. In particular, the evaluation device can determine one or more further signal points in each further signal section. The determination of the further signal points is possible in a simple manner if, as described above, the curve function of the further signal section is known.

In addition, the evaluation device can determine a further time and/or a further phase angle assigned to the further signal point. When determining several further signal points, the evaluation device can determine the time and/or phase angle assigned to the further signal point for each further signal point. This makes it easy to know at which further time and/or further phase angle the respective further signal point is present.

The number of determined further signal points can correspond to the number of determined signal points. This allows an offset characteristic curve, explained in more detail below, to be determined in a simple manner.

The further signal points of the second signal can be arranged offset from one another, in particular by a predetermined phase angle. Alternatively or additionally, the at least two further signal points can each be arranged offset from a reference point by a predetermined phase angle. In addition, the further signal points are arranged offset from one another in terms of time.

The evaluation device can assign a further signal point to each signal point. The assignment can be carried out in such a way that the assigned further signal point in the further signal section has the same phase angle as the signal point in the first signal section or that the assigned further signal point in the further signal section is arranged offset from the signal point in the signal section by a predetermined phase angle.

In a particular embodiment, at least one offset characteristic value can be determined, which depends on a time difference and/or phase angle difference between the first signal and the second signal. In particular, the first times assigned thereto can be determined for the signal points and the second times assigned thereto can be determined for the further signal points, and the offset characteristic value can be determined by determining a time difference between a pair of signal points. The time difference for a pair of signal points corresponds to a difference between the time assigned to the signal point and the further time assigned to the further signal point. Likewise, the offset characteristic value can be determined by determining a phase angle difference of a pair of signal points. The phase angle difference for a pair of signal points corresponds to a difference between the phase angle assigned to the signal point and the further phase angle assigned to the further signal point. When determining several offset characteristic values, an offset characteristic curve can be generated.

The determination of offset characteristic values is carried out in such a way that the time difference and/or phase angle difference of several pairs of signal points is determined. A first pair of signal points can have a first signal point and a first further signal point and a second pair of signal points can have a second signal point and a second further signal point. The first signal point can be adjacent to the second signal point and the first further signal point can be adjacent to the second further signal point. Adjacent is understood to mean that the two signal points are offset from one another in time and/or phase angle and there are no further signal points between the two signal points.

When determining the transmission signal time period, it can be checked whether the at least one offset characteristic value lies within a predetermined range. In particular, it can be checked whether a large number of offset characteristic values lie within the predetermined range. The predetermined range is limited by an upper and a lower limit. It is determined that the transmission signal time period corresponds to the time period of the received first and second signals in which the offset characteristic values lie within the predetermined range.

This test makes use of the knowledge that the time difference and/or phase angle difference between the received signals is constant in the time period in which the received signals contain the transmitted signal. This arises because the course of the transmission signal is essentially the same in both the first received signal and the second received signal. A transmission signal time period of the first and second received signals can then be determined in which the offset characteristic values lie in the predetermined range, i.e., have an essentially constant value. As a result, the transmission signal time period of the first and second signals in which the transmission signal is contained can be determined in a simple manner.

A more precise determination of the transmission signal time period can be achieved if a large number of offset characteristic values are determined and groups are formed, each of which has several offset characteristic values. The groups can be adjacent to one another. In addition, the groups can have the same time period and/or have the same number of offset characteristic values.

For each of the groups, a difference between a maximum value of the offset characteristic values and a minimum value of the offset characteristic values can be determined. The transmission signal time period can depend on at least one difference value between a maximum value and a minimum value of the offset characteristic values in a time range. Alternatively or additionally, a variance of the offset characteristic values can be determined. The transmission signal time period can depend on the variance values. At least one variance value can be determined for each of the groups. Variance is understood as the spread of a number of values around their mean.

The evaluation device can determine a time period in which several difference values are smaller than a predetermined threshold value, i.e., are below the threshold value. In addition, the evaluation device checks whether the time period, during which the difference values are below the predetermined threshold value, is no longer or not significantly longer than a predetermined time period. In the event that the time period for which the difference values are below the predetermined threshold value is longer or is significantly longer than a predetermined time period, there is an external signal that should not be further processed.

Alternatively or additionally, the evaluation device can determine a time period in which the variance values are smaller than a predetermined threshold value, i.e., are below the threshold value. In addition, the evaluation device can check whether the time period, during which the variance values are below the predetermined threshold value, is no longer or not significantly longer than a predetermined time period. In the event that the time period for which the variance values are below the predetermined threshold value is longer or significantly longer than a predetermined time period, there is an external signal that should not be further processed.

The predetermined time period can be a control period of the transmitter with the control signal or can depend on it. Thus, the time period during which the difference values and/or variance values are below the threshold value cannot be longer or not significantly longer than the control period. A difference value characteristic curve and/or the variance values can be formed by determining the difference value characteristic curve. The evaluation device determines that the transmission signal time period corresponds in particular to the time period in which the difference value or the difference values and/or the variance value or the variance values is or are below the predetermined threshold value, and which is longer than the predetermined time period, in particular a control period of the transmitter.

In a particular embodiment, the device can have a third receiver, which receives a third signal which contains at least part of the transmission signal and can be phase-offset in relation to the first signal and the second signal. The provision of three receivers enables a position of the object in three-dimensional space to be determined. In particular, a vector for the reflection object and, if the transmission time and/or the sound flight time is known, the position of this object in three-dimensional space can be determined.

The evaluation device can determine at least one further offset characteristic value, which depends on a time difference between the first signal and the third signal. In addition, the evaluation device can form at least one other offset characteristic value, which depends on a time difference between the second signal and the third signal. The determination of the further offset characteristic value and the other offset characteristic value can be carried out in a similar manner to the determination of the offset characteristic value.

Several further offset characteristic values can be determined. Groups can be formed which have several further offset characteristic values. For each of the groups, the difference between a maximum value of the further offset characteristic value and a minimum value of the further offset characteristic value can be formed. The evaluation device then determines a further time period in which the difference values are below the predetermined threshold value. Alternatively or additionally, a variance of the further offset characteristic values can be determined. At least one variance value can be determined for each of the groups. The evaluation device can determine a further time period in which the offset characteristic values are below the predetermined threshold value.

In addition, the evaluation device can determine whether the offset characteristic values are no longer or not significantly longer than the predetermined time period below the predetermined threshold value. In other words, it is checked whether the further time period corresponds at most or substantially to the specified time period. Here the specified time period is the specified time period mentioned above.

In addition, the evaluation device can determine several other offset characteristic values, wherein groups that have several other offset characteristic values are formed. For each group, the difference between a maximum value of the other offset characteristic value and a minimum value of the other offset characteristic value can be formed. The evaluation device can determine another time period in which the difference values are below the predetermined threshold value.

Alternatively or additionally, a variance of the offset characteristic values can be determined. At least one variance value can be determined for each of the groups. The evaluation device can determine a further time period in which the offset characteristic values are below the predetermined threshold value. In addition, the evaluation device determines whether the offset characteristic values are no longer or not significantly longer than a predetermined time period below the predetermined threshold value. In other words, it is checked whether the other time period corresponds at most or essentially to the specified time period.

In the event that the time period and the further time period, in particular and the further time period, correspond to the predetermined time period or are no longer than the predetermined time period, the evaluation device can determine an overlap time period in which the time period corresponds to the further time period and/or with overlaps with the other time period. In the event that the time period and/or the further time period and/or the other time period is longer than the predetermined time period, it is determined that it is an external signal and no overlap period is determined. The overlap time period corresponds to the transmission signal time period because the received signals in the overlap time period contain the transmission signal. The signal part of the respective signal located in the transmission signal time period can be further processed in order, for example, to determine a position of the object and/or a distance, in particular trilateration/angulation, between the object and the device.

The evaluation device can check whether the overlap period corresponds to a predetermined lower time period or is longer than the predetermined lower time period. If this condition is not met, the signal is not processed further. Unless an overlap section can be determined, the signals received via the receivers do not come from the same source.

The signal section of the received signal located in the transmission signal time period can be used to determine the position of an object and/or to determine the distance between the object and the device. In particular, the signal sections of the received signals located in the transmission signal time period can be used to determine the three-dimensional position of an object.

The distance between the receivers can be at most half a wavelength of the received signal and/or the highest frequency of the transmitted signal or the received signal. Preferably, the distance between the receivers can be less than half a wavelength of the received signal.

For determining a three-dimensional position, the transmitter and one receiver or two receivers can be arranged in a straight line. The third receiver is arranged in such a way that it is not arranged in a straight line. The transmitter and all receivers lie in a plane that has the straight line. The object is arranged such that it is spaced at a distance from the plane. In other words, the object is not located on the plane. The transmitter can act as one of the receivers after sending out the transmission signal. This means that the transmitter can send the transmit signal as well as receive signals.

It is particularly advantageous if the method according to the invention is used in three-dimensional position determination, in particular by means of the device described above.

The subject matter of the invention is shown schematically in the figures, wherein elements that are the same or have the same effect are usually provided with the same reference symbols. In the figures:

FIG. 1 shows a course of a received signal,

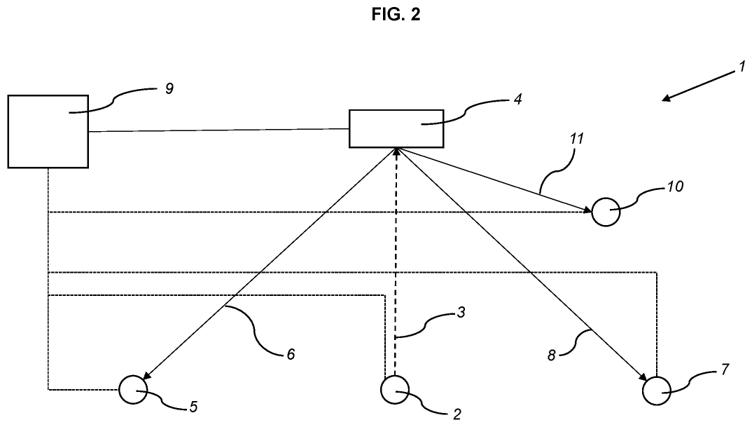

FIG. 2 shows a device for determining a transmission signal in the received signal shown in FIG. 1,

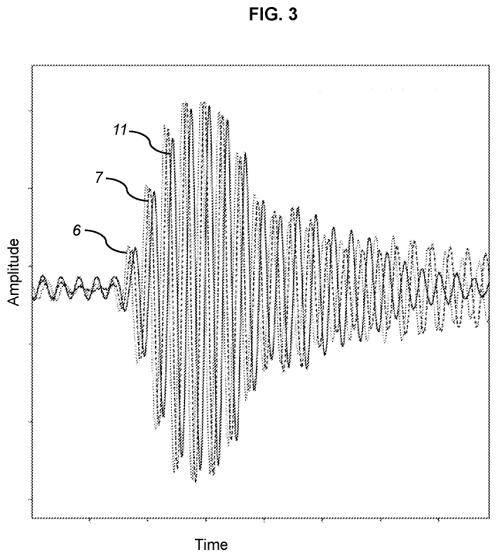

FIG. 3 shows part of the signals received via a first, second and third receiver of the device,

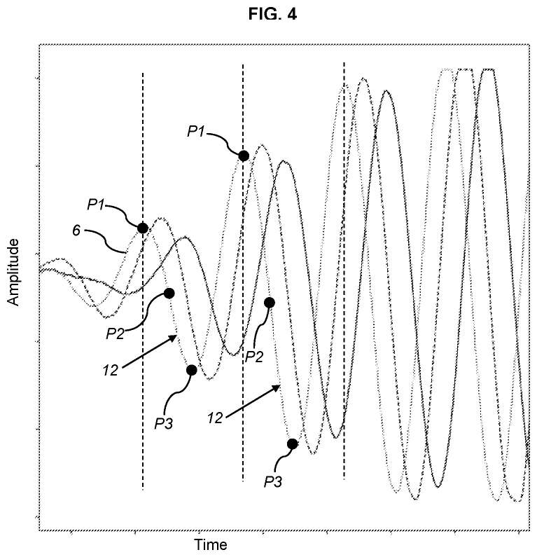

FIG. 4 shows an enlarged section of the signal curves shown in FIG. 3 wherein the signal points of the signal sections are shown,

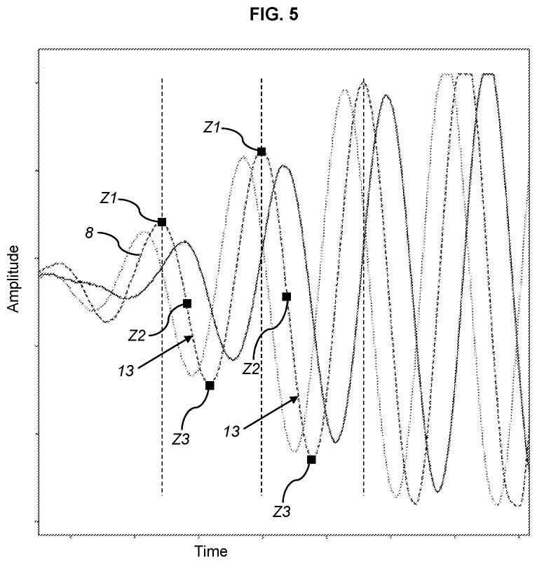

FIG. 5 shows an enlarged section of the signal curves shown in FIG. 3, wherein the further signal points of the further signal sections are shown,

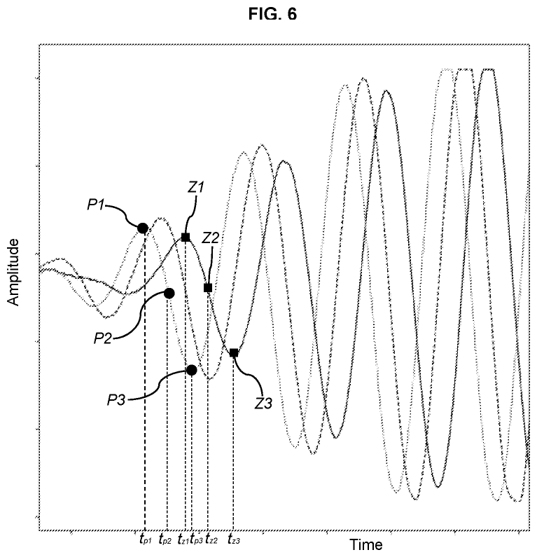

FIG. 6 shows an enlarged section of the signal curves shown in FIG. 3 with first and second signal points,

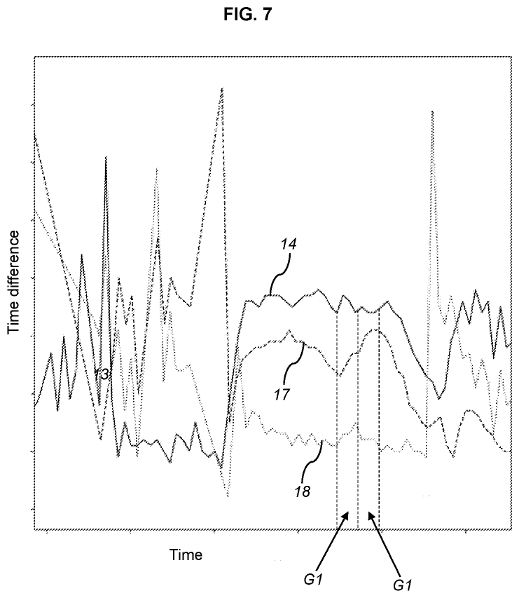

FIG. 7 shows a course of several offset characteristic curves,

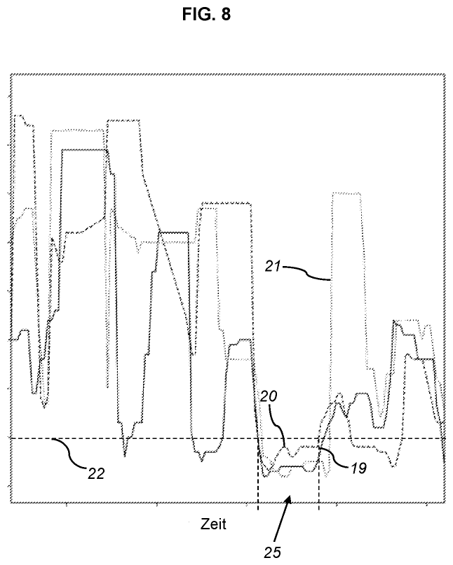

FIG. 8 shows a course of several difference value characteristic curves, and

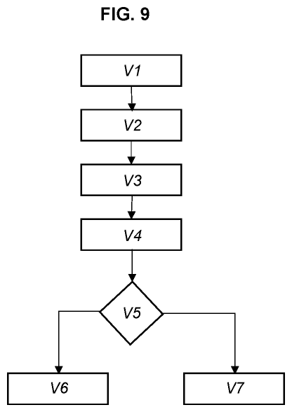

FIG. 9 shows a flowchart for determining the transmission signal in the received signal.

A device 1 shown in FIG. 2 for determining a transmission signal 3 in a received signal 6, 8, 11 has a transmitter 2 and three receivers 5, 7, 10, namely a first receiver 5, a second receiver 7 and a third receiver 10. In addition, the device 1 has an evaluation device 9, which is connected in terms of data technology to the transmitter 2 and each of the receivers 5, 7, 10. The data connection is shown in dashed lines in FIG. 2.

The transmitter 2 sends a transmission signal 3 to the environment. The transmission signal 3 is reflected on an object 4 that does not form part of the device 1. The first receiver 5 receives a first signal 6, the second receiver 7 receives a second signal 8 and the third receiver 10 receives a third signal 1. Each of the signals 6, 8, 11 received in FIG. 2 contains the reflected part of the transmission signal 1. However, the received signals also contain noise, such as ambient noise, which do not originate from the object 4. The transmitter 2 also sends a transmission signal 3 directly to the first receiver 5. This means that this transmission signal 3 is not reflected by the object 4.

FIG. 3 shows part of the signals 6, 8, 11 received via a first, second and third receiver 5, 6, 10 of the device 1. From FIG. 3 it can be seen that the individual signals detected are time-delayed from one another. This results from the fact that the receivers 5, 6, 10 receive at different times.

FIG. 4 shows an enlarged section of the signal curves shown in FIG. 3, wherein the signal points P1, P2, P3 of the signal sections 12 are shown. From FIG. 4 it can be seen that the first signal 6 is divided into several signal sections 12. The signal sections 12 have a phase angle range of 360°, wherein the boundaries of the signal sections 12 in FIG. 4 are symbolized by vertical dashed lines. In FIG. 4, two signal sections 12 of the first signal 6 are explicitly shown, but the entire first signal 4 can be divided into several signal sections 12.

The evaluation device 9 determines a curve function for each of the signal sections 12. In addition, the evaluation device 9 determines multiple signal points P1, P2, P3 in each of the signal sections 12. In the embodiment shown in FIG. 4, three signal points P1, P2, P3 are determined, namely a first signal point P1, a second signal point P2 and a third signal point P3. The first signal point P1 corresponds to the maximum of the signal section 12, the second signal point P2 corresponds to a turning point of the signal section 12 and the third signal point P3 corresponds to a minimum of the signal section 12. The first three signal points P1, P2, P3 have different phase angles.

The first signal point P1 12 is arranged in the signal section adjacent to the second signal point P2 in the signal section 12. The second signal point P2 is additionally arranged adjacent to the third signal point P3 in the signal section 12. The third signal point P3 is then additionally arranged adjacent to a first signal point P1 of an adjacent signal section 12.

The evaluation device 9 determines the associated time tₚ₁-tp3 for each determined signal point P1, P2, P3. In this respect, the evaluation device 9 is given the known times tₚ₁-tp3 at which the signal points P1, P2, P3 are present. Alternatively or in addition to determining the time, a phase angle determination is possible. However, the method described below uses only the time determination. The method can be carried out in an analogous manner if the phase angle difference is determined.

FIG. 5 shows an enlarged section of the signal curves shown in FIG. 3, wherein the further signal points Z1, Z2, Z3 of the further signal sections 13 are shown. From FIG. 5 it can be seen that the second signal 8 is divided into several further signal sections 13. The further signal sections 13 have a phase angle range of 360°, wherein the boundaries of the further signal sections 13 are symbolized in FIG. 5 by vertical dashed lines. Three further signal sections 13 of the second signal 8 are explicitly shown in FIG. 5, but the entire second signal 8 can be divided into further signal sections 13.

The evaluation device 9 determines a curve function for each of the further signal sections 13. In addition, the evaluation device 9 determines several further signal points Z1, Z2, Z3 in each of the further signal sections 13. In the embodiment shown in FIG. 5, three further signal points Z1, Z2, Z3 are determined, namely a further first signal point Z1, a further second signal point Z2 and a further third signal point Z3. The further first signal point Z1 corresponds to the maximum of the further signal section 13, the further second signal point Z2 corresponds to a turning point of the further signal section 13 and the further third signal point Z3 corresponds to a minimum of the further signal section 13. The three other signal points Z1, Z2, Z3 have different phase angles.

The first signal point Z1 is arranged in a signal section 13 adjacent to the second signal point Z2 in the signal section. The second signal point Z2 is additionally arranged adjacent to the third signal point Z3 in the signal section 13. The third signal point Z3 is then additionally arranged adjacent to a first signal point Z1 of an adjacent signal section 13.

The evaluation device 9 determines the associated time t_{z1}-t_{z3} for each determined second signal point Z1, Z2, Z3. In this respect, the times t_{z1}-t_{z3} for which the further signal points Z1, Z2, Z3 are available are known by the evaluation device 9.

FIG. 6 shows an enlarged section of the signal curves shown in FIG. 3, wherein the signal points P1, P2, P3 and the further signal points Z1, Z2, Z3 are shown. The evaluation device 9 determines a time difference between pairs of signal points. Pairs of signal points are formed by signal points P1, P2, P3 of the first signal 6 and further signal points Z1, Z2, Z3 of the second signal 8. The signal point P1, P2, P3 of the first signal 6 has the same phase angle as the further signal point Z1, Z2, Z3 of the second signal 8.

Three pairs of signal points are shown in FIG. 6. A first pair of signal points is formed by the first signal point P1 and the further first signal point Z1. A second pair of signal points is formed by the second signal point P2 and the further second signal point Z2. A third pair of signal points is formed by the third signal point P3 and the further third signal point Z3.

A time difference is determined for each pair of signal points. In particular, the time difference between points in time assigned to the signal points is determined. For the first pair of signal points, the time difference between the time tₚ₁ assigned to the first signal point P1 and the time t_{z1} assigned to the further first signal point Z1 is determined. The same calculation is repeated for the remaining two pairs of signal points. As a result, offset characteristic values are determined by forming the difference.

FIG. 7 shows a course of several offset characteristic curves 14, 17, 18. The vertical axis represents the time difference and the horizontal axis represents the time. The offset characteristic curve 14 results from a large number of offset characteristic values, which result from the above-described determination of the time difference between the signal points of the first signal 6 and the second signal 8.

FIG. 7 shows a further offset characteristic curve 17, which results from a large number of further offset characteristic values. The further offset characteristic values result from determining the time difference between the signal points of the first signal 6 and the third signal 11. In addition, another offset characteristic curve 18 is shown in FIG. 7, which results from a large number of other offset characteristic values. The other offset characteristic values result from determining the time difference between signal points of the second signal 8 and the third signal 11. The further offset characteristic curve 17 and the other offset characteristic curve 18 are determined in a similar manner to the offset characteristic curve 14.

Groups G1 are formed which have several offset characteristic values. Only two groups G1 are shown in FIG. 7. However, all offset characteristic values are grouped into groups G1. The offset characteristic curves 14, 17, 18 are each entirely divided into groups. The individual groups share the same time period and/or the same number of offset characteristic values. In each of the groups G1, a difference is formed between the maximum value in the time range and the minimum value of the offset characteristic value. This procedure takes place for each of the offset characteristic curves 14, 17, 18. Alternatively or additionally, a variance of the offset characteristic values is determined for each group G1. At least one variance value is thus determined for each group G1.

The result is three difference value characteristic curves that are based on the difference values determined and are shown in FIG. 8. A first difference value characteristic curve 19 is assigned to the offset characteristic curve 14. A second difference value characteristic curve 20 is assigned to the other offset characteristic curve 18 and a third difference value characteristic curve 21 is assigned to the further offset characteristic curve 17. Instead of the difference value characteristic curves, variance value characteristic curves can be determined. The method according to the invention works analogously if the above-mentioned variance values are used instead of difference values.

From FIG. 8 it can be seen that in the transmission signal time period 25, which is delimited by the vertical dashed lines, all three difference value characteristic curves 19, 20, 21, in particular no longer than a predetermined time period, are below a threshold value 22. In other words, the difference values of the respective difference value characteristic curve 19, 20, 21 have difference values in the transmission signal time period that are below the threshold value, i.e., are smaller than the threshold value. Likewise, variance value characteristics (not shown) in the transmission signal time period have variance values that are below the threshold value. The evaluation device 9 identifies this section as the transmission signal time period 25, in which all received signals 6, 8, 11 have the reflected transmission signal.

FIG. 9 shows a flow chart for determining the reflected transmission signal in the received signals 6, 8, 11. In a first step V1, the transmitter 2 sends out the transmission signal, which is reflected by an object 4. Alternatively, the transmission signal is received directly and is therefore not reflected by an object 4. The three receivers 5, 7, 10 receive the signals 6, 8, 11, which contain at least part of the transmission signal.

In a second step V2, the received signals are divided into signal sections and their curve function is determined in each case. In addition, the signal points are determined in the signal sections of the signals.

In a third step V3, a time difference and/or phase angle difference between signal point pairs, containing signal points of the first signal and signal points of the second signal, is determined. As described above, the time difference and/or phase angle difference between two different signals is determined. This is repeated for signal points of the first signal and signal points of the third signal and for signal points of the second signal and signal points of the third signal. As a result, the offset characteristic values of the offset characteristic curves 14, 17, 18 shown in FIG. 7 are obtained.

In a fourth step V4, groups are formed for each of the offset characteristic curves or offset characteristic values which have several offset characteristic values. For each group, the maximum and minimum values of the offset characteristic value are determined and the difference between the maximum and minimum values is determined. Alternatively or additionally, a variance of the offset characteristic values is determined for each group. This means that there is at least one variance value for each of the groups.

In a fifth step, a time period is determined based on the offset characteristic values, a further time period based on the further offset characteristic values and another time period based on the other offset characteristic values, in which the determined difference values and/or variance values of the respective offset characteristic curves are below the threshold value 22. In addition, it is determined whether the time period, the further time period and the other time period are below the threshold value for a predetermined time period, in particular no longer than the predetermined time period. The predetermined time period can be the time period of the control signal transmitted to the transmitter.

In the event that the conditions are met, an overlap time period is determined in which the time period, the other time period and the further time period overlap. The evaluation device determines that the overlap time period is the transmission signal time period.

If no such overlap time period can be determined, it is determined in a seventh step V7 that no transmission signal can be determined in the determined signals 6, 8, 11.

### LIST OF REFERENCE SYMBOLS

1 Device
2 Transmitter
3 Transmission signal
4 Object
5 First receiver
6 First signal
7 Second receiver
8 Second signal
9 Evaluation device
10 Third receiver
11 Third signal
12 Signal section
13 Further signal section
14 Offset characteristic curve
17 Further offset characteristic curve
18 Other offset characteristic curve
19 First difference value characteristic curve
20 Second difference value characteristic curve
21 Third difference value characteristic curve
22 Threshold value
23 First signal region
24 Second signal region
25 Time period
G1 Group
P1 First signal point
P2 Second signal point
P3 Third signal point
V1-V7 Method steps
Z1 Further first signal point
Z2 Further second signal point
Z3 Further third signal point

1.-34. (canceled)

35. A method for determining a transmission signal in multiple received signals, wherein the method comprises:
sending a transmission signal,
receiving a first signal, which contains at least part of the transmission signal, via a first receiver;
receiving a second signal, which contains at least part of the transmission signal, via a second receiver; and
determining the transmission signal in the received signals by comparing the received signals with one another, wherein comparing comprises a determination of a time difference and/or phase difference between the first signal and the second signal, wherein a transmission signal time period, in which the transmission signal is contained in the first signal and the second signal, depends on the determined time difference and/or phase difference.

36. The method according to claim 35, wherein the received first signal is divided into several signal sections, wherein one or more signal points are determined in the signal section.

37. The method according to claim 36, wherein a time and/or phase angle assigned to the signal point is determined and/or multiple signal points are determined, wherein the signal points are arranged offset from one another and/or are arranged offset from a reference point by a predetermined phase angle.

38. The method according to claim 35, wherein the received second signal is divided into several further signal sections.

39. The method according to claim 38, wherein:
a. a curve function of the respective further signal section is determined; and/or
b. the further signal section has the same phase angle range as the signal section.

40. The method according to claim 38, wherein one or more further signal points are determined in the further signal section.

41. The method according to claim 40, wherein:
a. a further time assigned to the further signal point and/or phase angle is determined; and/or
b. a number of determined further signal points corresponds to a number of determined signal points.

42. The method according to claim 40, wherein:
a. multiple further signal points are determined, wherein the further signal points are arranged offset from one another and/or offset from a reference point by a predetermined phase angle are arranged; and/or
b. each signal point is assigned a further signal point; and/or
C. the further signal point in the further signal section has the same phase angle as the signal point in the signal section or that the further signal point in the further signal section is arranged offset from the signal point in the signal section by a predetermined phase angle.

43. The method according to claim 35, wherein at least one offset characteristic value is determined which depends on a time difference and/or phase angle difference between the first signal and the second signal.

44. The method according to claim 43, wherein:
a. the offset characteristic value is determined by determining a time difference and/or phase angle difference from a pair of signal points; and/or
b. the time difference for at least one signal point pair corresponds to a difference between a time assigned to the signal point and a further time assigned to a further signal point; and/or
c. the phase angle difference for at least one signal point pair corresponds to a difference between a phase angle assigned to the signal point and a further phase angle assigned to the further signal point; and/or
d. the time difference is determined by several pairs of signal points, wherein a first signal point of the first signal is adjacent to a second signal point of the first signal and/or a first further signal point of the second signal is adjacent to a second further signal point of the second signal; and/or
e. it is checked whether the at least one offset characteristic value lies within a predetermined range, wherein it is determined that the transmission signal time period corresponds to the period in which several offset characteristic values lie within the predetermined range.

45. The method according to claim 35, wherein several offset characteristic values are determined, wherein groups which have several offset characteristic values are formed, and for each group a variance of the offset characteristic values is determined and/or the difference between a maximum value of the offset characteristic value and a minimum value of the offset characteristic value is formed.

46. The method according to claim 45, wherein:
a. a time period is determined in which difference values and/or variance values are smaller than a predetermined threshold value; and/or
b. it is checked whether a time period, in which the difference values and/or variance values and/or variance values are smaller than a predetermined threshold value, is not longer than a predetermined time period; and/or
c. the time period depends on at least one difference value between a maximum value of the offset characteristic value and a minimum value of the offset characteristic value of a group and/or on at least one variance value.

47. The method according to claim 46, wherein the time period in which several difference values and/or variance values are smaller than the predetermined threshold value, and which is not longer than a predetermined time period, is determined as a transmission signal time period.

48. The method according claim 35, wherein a third signal, which contains a reflected signal and is time-offset from the first signal and the second signal, is received via a third receiver.

49. The method according to claim 48, wherein at least one further offset characteristic value is formed, which depends on a time difference between the first signal and the third signal, and at least one other offset characteristic value is formed, which depends on a time difference between the second signal and the third signal.

50. The method according to claim 49, wherein:
a. several further offset characteristic values are determined, wherein groups are formed which have several further offset characteristic values, and for each group a variance of the several further offset characteristic values is determined and/or the difference between a maximum value of the further offset characteristic value and a minimum value of the further offset characteristic value is formed; and/or
b. several other offset characteristic values are determined, wherein groups are formed which have several other offset characteristic values, and for each group a variance of the several other offset characteristic values is determined and/or the difference between a maximum value of the other offset characteristic value and a minimum value of the other offset characteristic value is formed.

51. The method according to claim 50, wherein:
a. a further time period is determined in which the difference values and/or variance values are below a predetermined threshold value, wherein the transmission signal time period corresponds to an overlap time period in which the time period overlaps with the further time period; and/or
b. another time period is determined in which the difference values and/or variance values are below the predetermined threshold value, wherein the transmission signal time period corresponds to an overlap time period in which the time period overlaps with the other time period.

52. The method according to claim 35, wherein a signal section of the first signal and a further signal section of the second signal, which are compared to determine the transmission signal in the received signals, have the same phase angle range.

53. A device comprising:
at least one transmitter for sending a transmission signal;
a first receiver for receiving a first signal which contains at least part of the transmission signal;
a second receiver for receiving a second signal which contains at least part of the transmission signal; and
an evaluation device which compares the received signals with one another to determine the transmission signal in the received signals, wherein comparing comprises determining a time difference and/or phase angle difference between the first signal and the second signal, wherein a transmission signal time period, in which the transmission signal is contained in the first signal and the second signal, depends on the determined time difference.

54. The device according to claim 53, wherein:
a. the device has a third receiver for receiving a third signal containing the signal; and/or
b. a distance between the receivers is at most half a wavelength of the received signal; and/or
c. the transmitter is configured such that the transmission signal is a sound wave or an electro-magnetic wave.
